(19) United States
(12) Patent Application Publication
(10) Pub. No.: US 2008/0173197 A1
(43) Pub. Date: Jul. 24, 2008

(54) System for optimizing a regeneration schedule for a contact cleaning roller

(75) Inventors: Frank C. Corrado, Rochester, NY (US); James W. Fischer, Rochester, NY (US); Gary R. Larsen, Webster, NY (US); Ronald W. Sweet, Conesus, NY (US)

Correspondence Address: Robert C. Brown, 1207 Sandhurst Drive, Tallahassee, FL, 32312, US

(73) Assignee: Seratek, LLC

(21) Appl. No.: 11/656,051

(22) Filed: Jan. 22, 2007

(51) Int. Cl. B41F 35/00; B41F 33/00

(52) U.S. Cl. 101/425; 101/484

(57) ABSTRACT

A system for optimization of a regeneration schedule for a contact cleaning roller (CCR) used to remove particles from a substrate surface by being rolled along the substrate surface. In rolling along the surface, the CCR leaves a residual static charge. The level of leaving charge is sensed by a fieldmeter. When a CCR is first placed into service against a substrate, the leaving charge level is greater than the entering static charge level on the substrate ahead of the CCR. The entering charge is sensed by another fieldmeter, and the charge differential is determined and monitored. As the CCR becomes progressively loaded with particles during service, the leaving charge progressively diminishes. Thus the charge differential indicates inversely the particle loading of the CCR such that a charge differential limit can be set, below which the roller is removed from service and renewed by cleaning.

### TECHNICAL FIELD

The present invention relates to method and apparatus for regenerating the particle-removal capabilities of a contact cleaning roller; more particularly, to method and apparatus for deciding when a contact cleaning roller should be removed from service for regenerative cleaning (renewal); and most particularly, to method and apparatus for optimizing the length of service of a contact cleaning roller between regenerative cleanings thereof.

### BACKGROUND OF THE INVENTION

Methods and apparatus for cleaning sheets, rollers, and web substrates by impingment of a high-tack roller are well known. See, for example, U.S. Pat. Nos. 5,611,281 and 6,196,128, the relevant disclosures of which are incorporated herein by reference. A polymer-covered roller having an electrostatically-active surface or an adhesive surface is known generally in the art as a “contact cleaning” roller (CCR). A CCR functions by having an attraction for particles that is greater than the attraction of the substrate surface along which the roller is rolled, such that particles are transferred from the substrate surface to the surface of the CCR. Over time of use, a CCR becomes progressively loaded with transferred particles and consequently becomes less effective at removing additional particles. At some point in use, it is necessary to regenerate the cleaning surface by removing and discarding the particles, as is well known in the CCR art. Typically, CCRs are provided in pairs such that a second CCR may be engaged with the substrate to continue the particle-removal process while a first clogged CCR is disengaged from the substrate and removed for renewal. For a polymer-covered roller, such renewal typically takes the form of automated washing of a clogged CCR by rotating the roller surface against a web of consumable wetted cloth material, whereby charges binding the particles to the CCR are neutralized and the particles are transferred to the cloth material. For an adhesive tape-covered roller, such renewal takes the form of removal of an outer lap of tape, exposing a fresh convolution.

A problem in the prior CCR art is knowing when to change from one roller to the other. Typically, the first and second CCRs are interchanged on a predetermined schedule. This procedure is undesirable for at least three reasons.

First, if the pre-set service period for each roller is shorter than necessary (in-service roller is still functioning satisfactorily), the roller is cleaned more often than is necessary, resulting in excess use of consumable cleaning cloth or of adhesive tape.

Second, if the pre-set service period for each roller is too long, substrate cleaning will be inferior when the in-service roller becomes clogged but still remains in service.

Third, if an unexpected episode of intense particulate contamination of the substrate is encountered by the roller, or if the distribution of particles on the substrate surface is otherwise not random, the roller may become clogged well ahead of the programmed changeover time.

What is needed in the art is a system (method and apparatus) for determining when a contact cleaning roller reaches an unacceptable level of particle loading and should be removed from service and renewed, based upon an operating characteristic of the roller itself rather than upon a set period of service.

It is a principal object of the present invention to optimize a CCR cleaning cycle and thereby to minimize the expenditure of CCR-renewal materials.

### SUMMARY OF THE INVENTION

Briefly described, a CCR cleaning system for removing particles from a substrate surface comprises at least one CCR selectively contactable with the substrate surface. The CCR rolls along the surface which typically is drawn past the CCR as a continuous moving web, the CCR being rotatably mounted on a fixed axle of the system. In rolling along the substrate surface, a CCR leaves a residual (“leaving”) static charge on the substrate surface. The level of leaving static charge is sensed by a static-sensing device such as a fieldmeter in known fashion. When a CCR is first placed into service against a substrate, the leaving static charge is high. As the CCR becomes progressively loaded with particles during service, the leaving charge progressively diminishes. The decrease in leaving charge can be correlated experimentally with the particle loading of the CCR. In a first embodiment of the invention, a charge-loss action limit can be set, below which an alarm is sent, for example, to indicate that the roller should be removed from service and renewed by cleaning. In a second embodiment of the invention, the native charge on the web before contact with the contact cleaning roller (“entering charge”) is sensed by a second static-sensing device. The charge differential between the entering charge and leaving charge, which decreases with time of CCR use, is monitored and an alarm limit is set as in the first embodiment.

In a continuous-duty CCR system, first and second interchangeable CCRs are provided.

### BRIEF DESCRIPTION OF THE DRAWINGS

The present invention will now be described, by way of example, with reference to the accompanying drawings in which:

FIG. 1 is a schematic view of a first embodiment in accordance with the invention wherein an exemplary contact cleaning roller system is equipped with one static monitoring element for determining when a CCR is to be removed from service for renewal; and

FIG. 2 is a schematic view of a second embodiment in accordance with the invention wherein a second static monitoring element is included.

### DESCRIPTION OF THE PREFERRED EMBODIMENTS

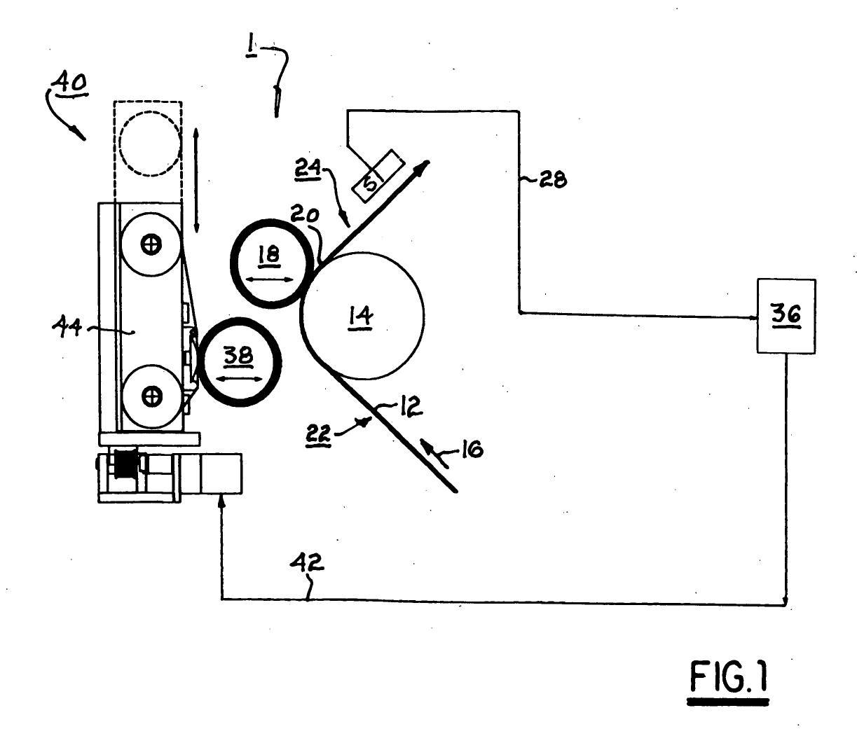

Referring to FIG. 1, in a first embodiment 1 in accordance with the invention for optimizing a regeneration schedule for a contact cleaning roller, a moving web substrate 12, for example a plastic photographic or magnetic film support, is passed around a backing roller 14 in a conveyance direction 16. A contact cleaning roller 18 is pressed against the surface 20 of substrate 12 in nipped relationship with backing roller 14 to transfer particles from substrate surface 20 onto the surface of CCR 18. CCR 18 may be any of a class of cleaning rollers known generally in the art as “particle transfer rollers”, which class includes at least rollers having electrically-active polymeric surfaces and also rollers having adhesive surfaces such as tape-covered rollers. The portion of substrate 12 ahead of CCR 18 is known in the art as the entering portion 22, and the portion of substrate 22 following CCR 18 is known in the art as the leaving portion 24.

In first embodiment 1, the static level on the surface of leaving portion 24 is measured by a static-measuring means S1. A signal 28 is transmitted to system control means 36, which may be a computer. At the beginning of CCR operation with a fresh CCR in place, a first static level may be measured on leaving portion 24 and stored in memory in control means 36 as a reference static level. Alternatively, a predetermined reference level may be stored in control means 36, which level may be either an average starting value for service of a renewed CCR or a threshold value for terminating service of a clogged CCR. In operation, as cleaning progresses, signal 28 is continuously monitored in control means 36.

In a first method for operating embodiment 1, a difference between the current signal amplitude and either the initial signal amplitude or the predetermined average starting value is continuously calculated. Because CCR 18 becomes progressively loaded, the current signal amplitude progressively decreases, thereby increasing the measured difference from the initial signal or the average starting value. Control means 36 is provided with an alarm limit with respect to the difference which, when reached causes control means 36 to send a control signal 42 to initiate a removal and regeneration cycle for CCR 18.

In a second method for operating embodiment 1, control means 36 is provided with an alarm limit defined by the threshold value for terminating service of a clogged CCR which, when reached, causes control means 36 to send a control signal 42 to initiate a removal and regeneration cycle for CCR 18.

Of course, control signal 42 may be simply an alarm signal that notifies an operator, lights an alarm light or audio annuciator, or otherwise makes known that an action limit has been reached. Any action prompted by control signal 42 is comprehended by the invention.

Preferably, static-measuring means S1 is a fieldmeter. However, other static-measuring means are fully comprehended by the invention, including but not limited to a static bar device (not shown) run from a DC power supply, as is known in the art of static measurement.

A typical DC static-measuring system employs a tandem set of static bars, the two bars being mechanically connected about 1″ apart. One bar emits a positive ion flow and the other bar emits a negative ion flow. A controller is incorporated into the power supply to measure the current flows to each bar. As the demand for positive or negative ion flow changes in response to changes in static charge on the moving web, a device controller sends a signal which can be used to alarm the status.

In operation, a clean CCR produces a large positive ion flow initially, generating a high static charge on the cleaned substrate, and the device output is high. A clogged CCR produces a small positive ion flow, and device output is low.

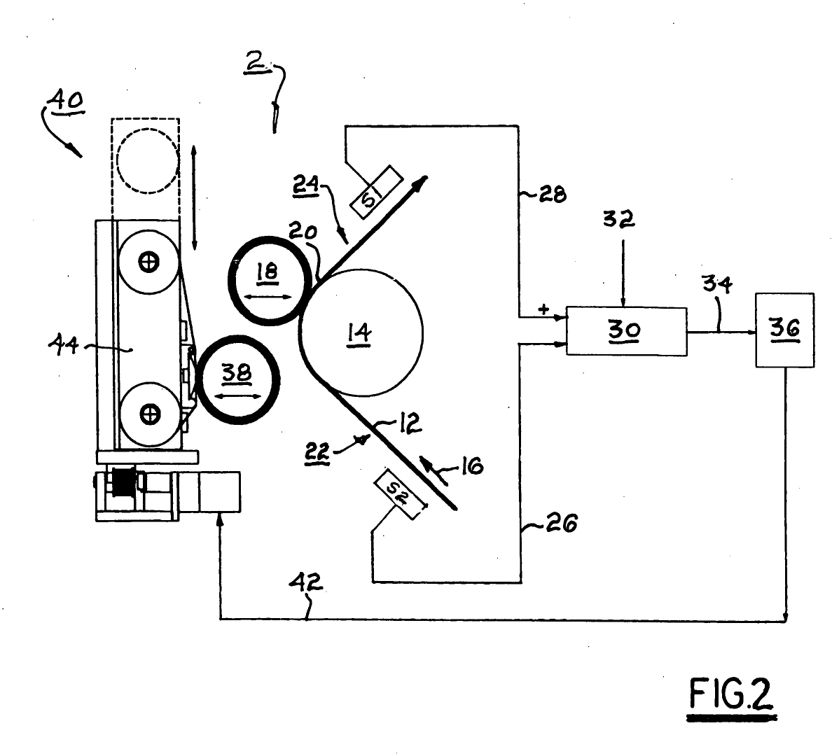

Referring now to FIG. 2, in a second embodiment 2 in accordance with the invention, the static level on the surface of entering portion 22 is measured by a second static-measuring means S2 indicated as entering electric signal 26, and the static level on the surface of leaving portion 24 is measured by first static-measuring means S1 indicated by leaving electric signal 28 as in first embodiment 1. A differential static level monitor 30 continuously determines the numerical difference between signals 26,28 and compares the calculated difference to a predetermined difference action value 32.

Referring now to FIGS. 1 and 2, for continuous particle removal from surface 20 a second CCR 38 is required which may be alternated in service with first CCR 18. The first and second CCRs 18,38 are part of a system 40 for continuous particle removal and alternating CCR regeneration as is well known in the prior art. See, for example, U.S. Pat. No. 5,611,281. In a currently preferred response embodiment, controller 36 sends signal 42 to system 40 which responds by translating second CCR 38 into service in nipped relationship with backing roller 14; translating first CCR 18 out of service; and regenerating the surface of first CCR 18 by contact with a regeneration unit 44. When second CCR 38 becomes clogged, as indicated by the differential signal at monitor 30, the process is reversed: first CCR 18 is placed back into service, and second CCR 38 is tranlated out of service for regeneration.

In this manner, a substrate 12 of indefinite length may be cleaned continuously of particles. Further, because CCR regeneration is carried out based on the actual degree of clogging of the CCRs, the regeneration schedule is optimized and the consumption of cleaning materials in regeneration unit 44 is minimized.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for optimization of a regeneration schedule for a contact cleaning roller used to remove particles from a substrate surface by being rolled along the substrate surface, comprising:
a) a static charge detection means disposed adjacent said substrate for determining an electrostatic charge level thereupon at a location after said substrate has made contact with said contact cleaning roller;
b) means for monitoring said electrostatic charge level during use of said contact cleaning roller on said substrate surface;
c) means for comparing said monitored electrostatic charge level to a predetermined action limit value; and
d) means for causing an alarm signal when said monitored electrostatic charge level reaches a specific relationship to said predetermined action limit value.

2. A system in accordance with claim 1 wherein said specific relationship is a maximum allowable difference between said monitored electrostatic charge level and a value selected from the group consisting of a value of an initial electrostatic charge level and a predetermined average starting value for an electrostatic charge level.

3. A system in accordance with claim 2 wherein said specific relationship is a zero difference between said monitored electrostatic charge level and a predetermined average minimum allowable value.

4. A system in accordance with claim 1 comprising the further step of removing said contact cleaning roller from service in response to said alarm signal.

5. A system in accordance with claim 2 wherein said charge detection means is a first charge detection means, and wherein said electrostatic charge level is a first electrostatic charge level, and wherein said location is a first location, comprising:
a) a second charge detection means disposed adjacent said substrate for determining a second electrostatic charge level at a second location before said substrate has made contact with said contact cleaning roller;
b) means for monitoring said second electrostatic charge level during use of said contact cleaning roller on said substrate surface; and
c) means for determining a difference between said first electrostatic charge level and said second electrostatic charge level, wherein said second electrostatic charge level defines said initial electrostatic charge level.

5. A system in accordance with claim 4 comprising the further step of removing said contact cleaning roller from service in response to said alarm signal.

6. A method for optimization of a regeneration schedule for a contact cleaning roller used to remove particles from a substrate surface by being rolled along the substrate surface, comprising the steps of:
a) determining an electrostatic charge level at a location after said substrate has made contact with said contact cleaning roller;
b) monitoring said electrostatic charge level during use of said contact cleaning roller on said substrate surface;
c) comparing said monitored electrostatic charge level to a predetermined action limit value; and
d) causing an alarm signal when said monitored electrostatic charge level reaches a specific relationship to said predetermined action limit value.
